(19) United States
(12) Patent Application Publication
(10) Pub. No.: US 2004/0057378 A1
(43) Pub. Date: Mar. 25, 2004

(54) Flow control in a packet-switched communication network using a leaky bucket algorithm

(76) Inventor: Petri Gronberg, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/450,514

(22) PCT Filed: Dec. 18, 2001
(86) PCT No.: PCT/FI01/01120

(30) Foreign Application Priority Data
Dec. 22, 2000 (FI) 20002848

(51) Int. Cl. H04L 12/26

(52) U.S. Cl. 370/230; 370/252

(57) ABSTRACT

A buffer in a packet control network unit may overflow or underflow during data transmission from an external network to a user terminal, thus causing many kinds of problems in data transmission. The problems can be prevented in a packet network providing a data flow control algorithm performed by the packet control unit. The packet control unit indicates to the network node, from which it receives data packets, the actual transmission rate of a specified data flow, as well as the buffering capacity for that flow. Then the said network node adjusts its transmission rate for the indicated flow.

### FIELD OF THE INVENTION

The present invention relates generally to flow control in a telecommunications network, especially in a packet network.

### BACKGROUND OF THE INVENTION

In the GSM (Global System for Mobile communication) network, data is sent on the normal circuit-switched traffic channel, which can be rather inefficient. A communication path is established between the transmitter and the receiver when all packets have been received. Thus, channel capacity is dedicated for the duration of the connection even if no data is being transferred. However, charging is based on the connection time.

GPRS (General Packet Radio Service) is a system that supports packet-switched data traffic over a GSM network infrastructure. It provides methods that enable GSM operators to share physical resources efficiently between packet-switched services and circuit-switched services. In a GPRS system each data packet is routed individually from the source to the destination, for example, from a GPRS mobile to an external packet data network. In contrast to a circuit-switched system, in the GPRS system the radio resources at the air interface are reserved only when there are data packets to transmit, i.e. channel capacity is not utilized when no data is being transferred between a user terminal and a second party, such as a service provider. Packet switching is used to optimize the use of the bandwidth available in the network. The charge of the user is based on the amount of data transmitted and received, not on the connection time.

FIG. 1 shows a simplified block diagram of the GSM/GPRS system architecture.

The network subsystem NSS 100 comprises a mobile services switching center MSC 101. A base station subsystem BSS 102 is located between A and air interfaces comprising base station controllers BSC 103, each controlling the base transceiver stations BTS 104 connected to them. The base transceiver stations are in radio communication across the air interface with terminals TE, such as a GPRS mobile 105. The mobile network is connected to other networks, such as a public-switched telephone network PSTN 111, for example.

A GPRS trunk line is based on two logical elements: a SGSN (Serving GPRS Support Node) 107 and a GGSN (Gateway GPRS Support Node) 108. In addition, a GPRS comprises other elements, such as IP (Internet Protocol) routers, fire walls, and servers (not shown in the figure).

The gateway GPRS support node acts as a router between a GPRS system and an external packet data network. It routes data packets to and from the GPRS support node currently serving the given GPRS mobile.

The serving GPRS support node SGSN is at the same hierarchical level as the mobile switching center MSC. It maintains information about the GPRS mobile's location inside its service area and performs security and user access control functions. During data transfer the serving GPRS support node sends and receives data packets to and from the given GPRS mobile via a base station subsystem. The serving GPRS support node requests routing information and subscriber information from the HLR (Home Location Register) 109, where all the subscriber information is permanently stored.

The PCU (Packet Control Unit) 106 is usually located within the base station controller BSC or in the base transceiver station BTS. It is responsible for reserving, scheduling, and releasing the radio resources at the air interface and attending GPRS data communication to cells.

The GPRS and GSM systems are connected through different interfaces, though only some of these are shown in the figure. The Gb interface carries the signaling and the payload between the base station subsystem and the serving GPRS support node. Other interfaces shown in FIG. 1 are the Gn interface between the serving GPRS support node and the gateway GPRS support node, the Gr interface between the serving GPRS support node and the home location register, the Gi interface between the gateway GPRS support node and an external network, such as a PSDN (Packet-Switched Data Network) or a PDN (Packet Data Network), and the Gp interface between the gateway GPRS support node and another GPRS network 110.

The transmission protocols needed when data packets are carried over the GPRS network are described briefly in the following.

The IP (Internet Protocol) is the dominant protocol at the network layer. It is used for internetwork routing of data between hosts and across network links. The TCP (Transmission Control Protocol) at the transport layer is connection oriented, reliable protocol for connecting applications between internetworked hosts. It is widely used for various applications.

The LLC (Logical Link Control) protocol provides a logical connection between a serving GPRS support node and a GPRS mobile. It can operate either in an acknowledged or an unacknowledged operation mode. Whereas the former provides a reliable link between a serving GPRS support node and a GPRS mobile, the latter supports the transmission of data packets without ARQ (Automatic Repeat Request) procedures.

The BSSGP (Base Station Subsystem GPRS Protocol) provides a connection between the serving GPRS support node and the base station subsystem. Among other functions it is in charge of flow control between the serving GPRS support node and the base station controller.

The RLC (Radio Link Control) protocol provides a reliable physical connection between a packet control unit and a GPRS mobile. Also the RLC protocol layer can operate either in an acknowledged or in an unacknowledged operation mode. Whereas the former provides a reliable link over the air interface, the latter supports the transmission of data packets without ARQ procedures.

The MAC (Medium Access Control) protocol defines the procedures whereby the shared radio resources are reserved, scheduled, and released for packet data transfer. It also handles the mapping of RLC data packets in the GSM physical channel.

The serving GPRS support node transfers data packets over the Gb interface to the packet control unit according to a leaky bucket type of flow control algorithm. It controls the data flow using certain parameter values, such as a bucket size value B, a LLC frame size, a leak rate value R, and a buffering capacity value B_max for the given flow. The flow control parameter values are determined by the packet control unit, which is allowed to send the parameters to the serving GPRS support node once within a predetermined period of time.

When data packets are sent through the GPRS network to a GPRS terminal, the gateway GPRS support node routes the data packets to the serving GPRS support node, where the packets are encapsulated or segmented, if needed, into LLC frames. Then the frames are transmitted to the packet control unit, where they are buffered until they are transmitted over the air interface to the final destination, the GPRS terminal. The packet control unit may have a separate buffer for each data flow, or alternatively the packet control unit may have a common buffer for all data flow, possibly with some flow-specific occupancy restrictions.

The first problem is that the transmission capacity is restricted at the air interface, for which reason the data cannot always be transmitted at the same rate as the data might be transmitted from the serving GPRS support node. The lack of transmission capacity sets high buffering requirements to the packet control unit.

When transmission through the air interface is congested, the degree of filling in the buffer in the packet control unit increases. In the worst case the buffer overflows and some data packets are lost. This leads typically to the situation where the TCP protocol reacts by starting a so-called slow start algorithm, which means that the data is then transmitted more slowly than previously, i.e. at a decreased bit rate. This is undesirable because the RLC connection between the sender and the recipient is established only when there are data packets to transmit over the air interface. At the beginning of the slow start procedure this means roughly that the recourses over the air interface have to be established and released for each data packet transmitted. Of course, this is not practical and causes time wastage.

The second problem is underflow of the buffer in the packet control unit. This might occur if the packet control unit can unload the buffer faster than the serving GPRS support node transmits the data. This leads to a similar situation as described above in association with overflow of the buffer, i.e. the resources over the air interface are first released and then re-established whenever the buffer in the packet control unit underflows.

The third problem is that the packet control unit needs to control multiple data flows under varying conditions. When the packet control unit receives a data packet from the serving GPRS support node or when a data packet is transmitted completely over the air interface, the degree of filling in the buffer of the packet control unit is increased or decreased abruptly by the size of the data packet, 1500 bytes, for example. On-the other hand, the data rate through the air interface varies if there are changes in the radio conditions or if the radio resources are shared by a varying number of data flows.

The fourth problem is that multiple data flows must be controlled with a limited number of flow control messages from the packet control unit to the serving GPRS support node. The reason for this is that the flow control messages consume bandwidth at the Gb interface, as well as generating a processing load on the network elements.

At present there is no optimized method for controlling a plurality of data flow at the Gb interface so that

1) the buffer in the packet control unit never overflows,

2) the buffer in the packet control unit never underflows in a situation where the serving GPRS support node has some data to transmit, and

3) the number of flow control messages remains limited.

The third and fourth problem together lead to the situation where it is difficult to determine the data rate at which the serving GPRS support node should transmit data to the packet control unit.

An optimal situation would be that the packet control unit controls a plurality of data flow with a limited number of flow control messages so that the buffer in the packet control unit never underflows or overflows.

### SUMMARY OF THE INVENTION

The objective of the invention is to overcome the problems described above by providing reliable, adaptable data flow control for data frames to be sent from the network to mobile stations over the air interface.

The objective is achieved through a method and a system characterized by what is stated in the independent claims.

The system comprises at least a packet control unit in the base station subsystem, which receives data frames from an external network via a serving GPRS support node, buffers the data frames received; and transmits them further over the air interface to a plurality of mobile stations.

The packet control unit controls the downlink flow of frames according to a flow control algorithm. The idea is that the packet control unit computes a real leak rate value for each downlink data flow separately. Then each leak rate value is corrected with a correction factor, which depends on the degree of filling in the buffer of the packet control unit. Then the parameter value computed and determined by the packet control unit is included in a flow control message sent to the serving GPRS support node at predetermined time intervals. The serving GPRS support node adjusts its transmission rate for each data flow according to the instructions received from the packet control unit.

The number of flow control messages that need to be sent from the packet control unit to the serving GPRS support node can be limited. The advantage of this is that the use of resources is economized.

The number of flow control messages can be limited in different ways.

One way is that the packet control unit determines the mobile station whose data flow needs the most control in a served cell. This is done by computing a relative difference between a real leak rate value and the currently used leak rate value for each of a plurality of data flows and on that basis selecting the data flow corresponding to the largest value computed. Furthermore, the packet control unit sends only one flow control message per served cell controlling the data flow selected by the flow control algorithm.

Another way to limit the number of flow control messages is that the packet control unit selects a plurality of data flows needing control and sends a separate flow control message for each flow selected. This is done by computing a relative difference between a real leak rate value and the currently used leak rate value for each of the plurality of data flow and comparing each computed value with a predetermined threshold value. The packet control unit sends a flow control message for a given flow only if the computed value exceeds the predetermined threshold value.

The flow control algorithm is repeated at predetermined time intervals for each cell or, alternatively, for each mobile station in the cell. In other words, the present invention provides a data flow control method at two levels, i.e. the flow control can be performed for controlling the total data flow being sent to a cell or to a specified mobile station.

### BRIEF DESCRIPTION OF THE DRAWINGS

The invention is described more closely with reference to the accompanying drawings, in which

FIG. 1 illustrates the implementation of the known structure of the GSM/GPRS network,

FIG. 2 illustrates successive data packet transmission through the GSM/GPRS network from an external network to user terminals,

FIG. 3 shows as a flowchart an example of an algorithm used in the service GPRS support node, and

FIG. 4-6 are flowcharts showing some examples of the basic operation of an algorithm used in the packet control unit.

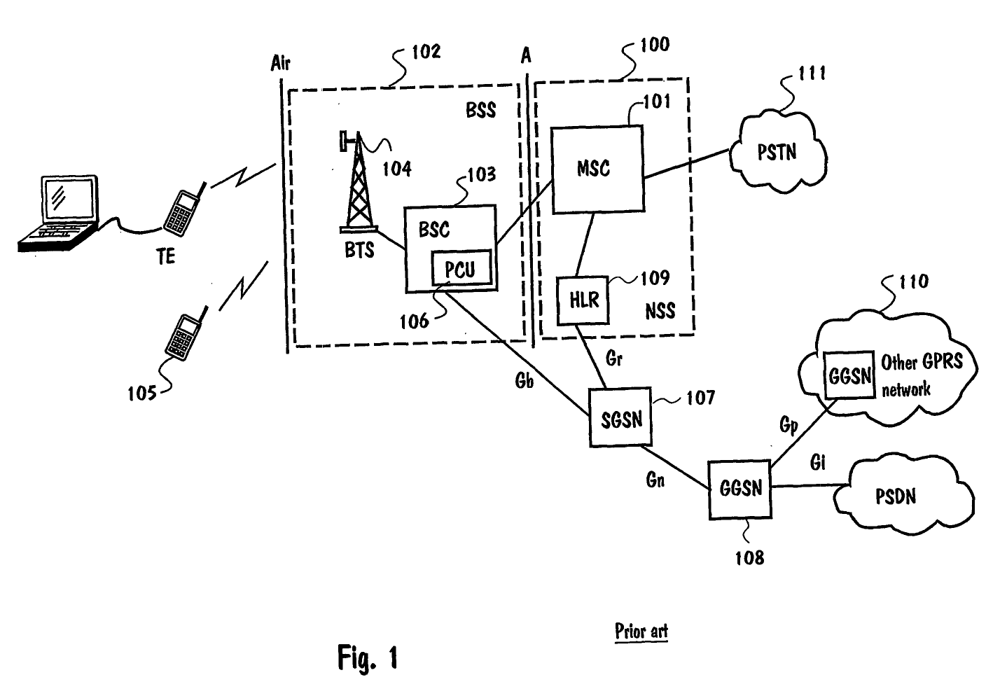

### DETAILED DESCRIPTION OF THE INVENTION

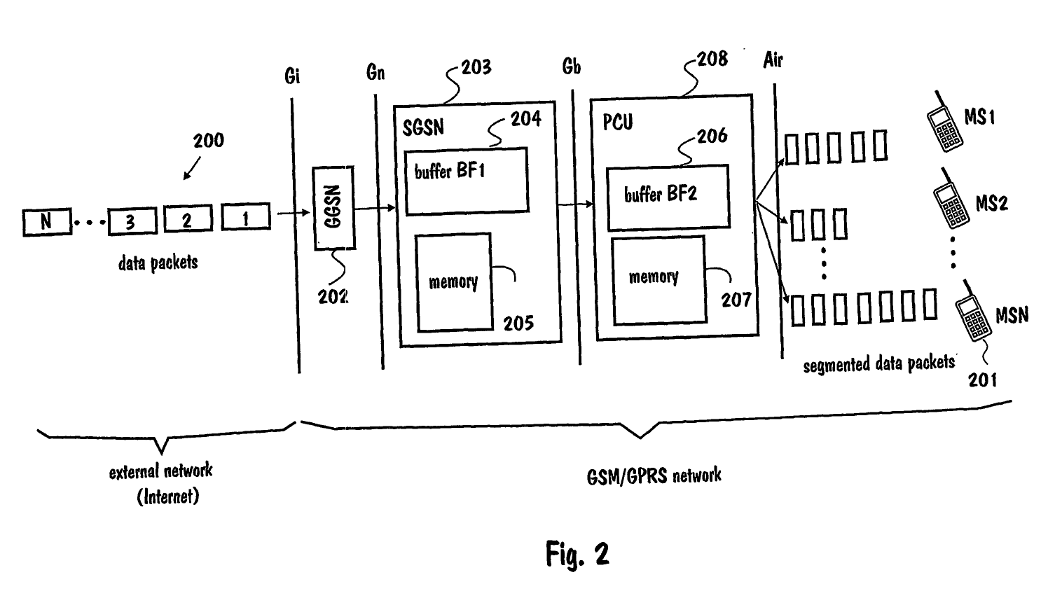

FIG. 2-6 illustrates examples where data frames are sent from the ternet to a GPRS mobile.

From now on a serving GPRS support node is called an SGSN, a gateway GPRS support node a GGSN, and a packet control unit a PCU.

It is to be noted that frames are also called packets in the following.

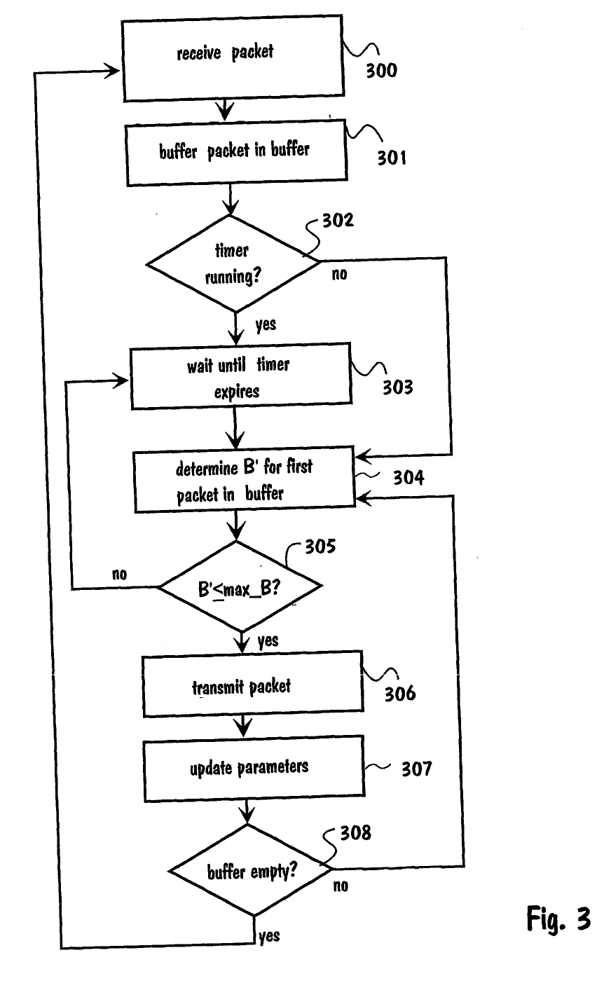

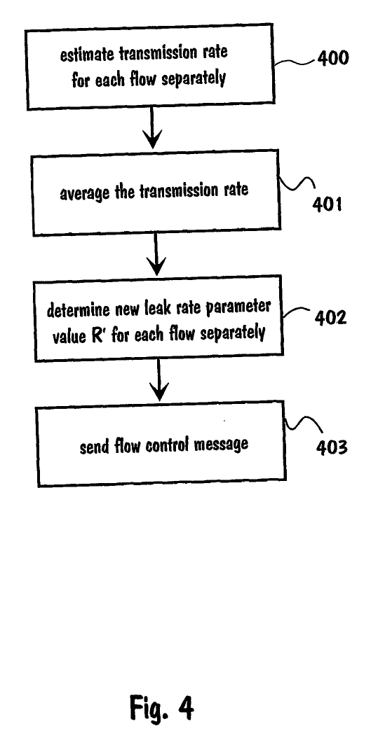

First, briefly is to be considered data flow through a GPRS network from the Internet to GPRS mobiles, with reference to FIG. 2. Then flow control between the base station subsystem and SGSN is considered in more detail from the standpoint of an SGSN with reference to FIG. 3 and then from the standpoint of a PCU with reference to FIG. 4-6.

In FIG. 2 successive TCP data packets 200 are transmitted from the Internet to GPRS mobiles 201. The data packets are transmitted over a Gi interface to a GGSN 202, which routes the packets further over a Gn interface to a serving SGSN 203. At the SGSN the packets are first stored in a buffer BF1 204 in the order received. Data packets may arrive in a different order than they were transmitted. However, each of the packets contains a unique number, and the numbers are assigned sequentially. It is logically a simple task to reorder the packets received on the basis of a sequence number at the final destination. According to an algorithm and predetermined parameter values (saved in a memory 205), the SGSN encapsulates or segments, if needed, the packets into LLC frames and transmits them further over a Gb interface to a PCU 208, where they are stored in a buffer BF2 206. Radio recourses are allocated by the PCU, and the allocations are in effect until they are released. Before actually sending data packets to GPRS mobiles, however, the PCU must segment the data packets into a smaller packet size, i.e. into RLC blocks suitable for downlink radio transmission.

The PCU counts the amount of the data or more accurately the number of bytes transmitted over the air interface to GPRS mobile stations. Then according to the PCU flow control algorithm, the flow-control parameters are updated for each downlink data flow and stored in the memory 207, and in a control flow message the SGSN is informed of the new parameter values.

FIG. 3 shows as a flowchart an example of an algorithm used in the SGSN. The algorithm is a so-called leaky bucket type algorithm, and it is used to adjust the transmission rate to a certain value. The same algorithm is applied for each data flow, but the flow control parameter values differ for each data flow.

At the first step 300 the SGSN receives data packets from an external network via the GGSN.

In the order received, the data packets are buffered into a buffer BF1 301 that serves as a flow control buffer. Each data flow has a flow control buffer of its own. Therefore, the buffer BF1 in the SGSN can be considered to be a collection of sub-buffers, each of which serves as a flow control buffer for a given data flow. The assumption in this example is that in the beginning the flow control buffer is empty.

When a data packet has been stored in the flow control buffer, a check is made as to whether the timer is running 302. If the answer is YES, then the flow control algorithm is already delaying a packet and nothing can be done until the timer expires 303. If the answer is NO, then the flow control algorithm is able to operate and the next step in the flowchart is step 304

The flow control algorithm in the SGSN needs some parameter values for operation. These parameter values are specific for each data flow, and they are stored in the memory of the SGSN. The main parameter values are: leak rate R, current bucket size B, maximum bucket size B_max, LLC frame size L, and time T_last (initially zero) when the last LLC frame has been transmitted within the flow concerned.

The leak rate R corresponds to the rate at which the LGSN is allowed to transmit data within a given flow. It has initially a certain default value (R_Def, but its value can be updated by the PCU in the way described in detail below.

With the current bucket size B, the SGSN estimates how much data the PCU has buffered for a given flow. In other words, the current bucket size B describes virtually the degree of filling in the PCU's buffer BF2. The initial value for the current bucket size is zero.

With the maximum bucket size B_max, the SGSN estimates the maximum capacity of the PCU's buffer BF2. It has initially a certain default value (B_max_def), but its value may be changed for a certain data flow by the PCU.

In operation the flow control algorithm computes a predicted value. B′304 for the current bucket size B using the length of the first data packet in the flow control buffer in computation, by the following equation:

B′=B+L−(T_now−T_last)*R,

where L is the length of the first packet in the flow control buffer and T_now is the current time. Then the flow control algorithm compares whether B′ is smaller than or equal to B_max value, step 305. If the answer is YES, the packet, i.e. the first LLC frame in the flow control buffer, can be transmitted to the PCU 306 and removed from the flow control buffer BF1. In this context the SGSN updates the values of the current bucket size B and the time T_last 307 in the following way:

```
If B’ < 0,
    then B = L
        T_last = T_now
    else
        B = B’
        T_last = T_now
```

The new determined parameters are stored in the memory in the SGSN.

The next step is to check whether or not the flow control buffer is empty 308. If the answer is NO, then the flow control operation is repeated.

The data packet that is currently the first in the flow control buffer is handled first. If the answer is YES, the flow control operation is suspended until there is a packet in the flow control buffer.

If the answer after comparison in 305 is NO, the SGSN is not allowed to transmit the current data packet to the PCU because it is estimated that there is currently insufficient space for the packet in the PCU's buffer BF2. However, the SGSN may assume that the PCU is able to unload its buffer by a leak rate of R. Based on this value the SGSN is able to compute the time point when there will be enough space for the packet in the PCU's buffer. So the SGSN keeps the packet in its flow control buffer and sets a timer based on the following computation:

TrigTime=T_now+(B′−B_max)/R

At TrigTime, i.e., at the moment when the timer expires, the flow control algorithm is repeated from step 303 or 304. On the other hand, the TrigTime can also be determined as the time the timer is running, but in that case T_now has to be deleted from the equation above.

Note that in practice the flow control algorithm of the SGSN is applied to fill the PCU's buffer BF2 with data and then maintain this situation by transmitting more data at the rate at which the PCU is able to unload the buffer.

In the absence of an efficient and reliable flow control algorithm, several problems may arise as explained above. The basic purpose of flow control is to enable the receiver, here the PCU, to control the rate at which it receives data, so that the packet arrival rate is adjusted to the transmission rate over the air interface to a plurality of GPRS mobile stations in a served cell.

The method for such flow control implementation in the PCU is described in the following, whereby the problems relating to the flow control are overcome.

The base station subsystem GPRS protocol provides a connection between the SGSN and the base station subsystem. When the SGSN sends a data packet to a GPRS mobile station via the base station subsystem, the packet is first stored in the buffer BF2 in the PCU. The PCU has a certain buffer size available for each data flow. Therefore, the buffer BF2 in the PCU can be considered to be a collection of sub-buffers, each of which serves a given data flow. The flow control algorithm is not, however, specific for any particular buffer configuration.

It is assumed that the buffer BF2 is empty in the beginning. After that, in order to transmit the packet further to the GPRS mobile station in question, a channel for downlink transmission is allocated, i.e. from the network to the GPRS mobile station. Before sending the packet to the GPRS mobile station, the packet must be segmented into smaller packets. Of course, in practice there is a plurality of GPRS mobile stations in a cell to which the PCU transmits packets arriving form the SGSN. All the packets are handled in similar way. Each packet received is buffered into the buffer BF2 until it is transmitted to the destination over the air interface. The PCU controls the downlink flow of LLC frames according to a BSSGP flow control algorithm. The flow control parameter values are updated and the SSGN is informed of the new values at predetermined time intervals. The BSSGP flow control algorithm is described in detail in the following with reference to FIG. 4.

FIG. 4 shows as a flowchart an example of the basic operation of the algorithm used in the PCU. The procedure below is performed at predetermined time intervals for each cell.

For simplicity only one cell is considered in this example. It is assumed that in the cell there is a plurality of GPRS mobile stations receiving data simultaneously from the GPRS network. At stage 400 the PCU estimates the real transmission rate for each downlink data flow separately as well as for the total data flow for the cell. This requires that the PCU must know the amount of data that has already crossed the air interface. That can be accomplished simply by counting the number of bytes transmitted during a predetermined time interval. The number of bytes can be determined also in some other way depending on the implementation used.

The transmission rate R can be determined for each separate data flow by an equation:

R=b/t,

where b is the number of bytes transmitted within a time period of t. The time t could be, for example, the predetermined time period that determines the repetition rate of the flow control procedure. Then the transmission rate R is averaged for each separate data flow 401 using the following iteration:

Tr_{—}R=α*R+(1−α)*Tr_{—}R_{—}Prev,

where Tr_R is the averaged transmission rate for each data flow. R is the transmission rate determined as explained above; α is a factor whose value is between 0 and 1; Tr_R_Prev is the averaged transmission rate that was computed during the previous iteration.

At the moment when the downlink TBF (Temporary Block Flow) from the base station subsystem to a GPRS mobile station is established, Tr_R_Prev is zero. The Tr_R for each data flow as well as for the total data flow within the cell is stored in the memory.

The next step 402 is to determine a new leak rate parameter value R′ for each downlink flow separately. This is the most important function of the flow control algorithm. The new leak rate parameter value R′ is determined using the following equation:

R′=Tr_{—}R+(1D/B_{—}Def))*R_{—}Def,

where D is the amount of data currently buffered in BF2 for the given flow. B_Def is a definition value that corresponds to the B_max parameter used by the SGSN. Therefore, it determines the capacity of the virtual buffer that the SGSN intends to fill. Basically B_Def is a variable which may be specific according to a flow for each GPRS mobile station or for the cell. In the latter case the B_Def variable can be dimensioned on the basis of the number of time slots reserved for GPRS transmissions in the cell.

R_Def is the default value of the leak rate parameter R used by the SGSN. The same R_Def value is used for each data flow from the network to GPRS mobile stations, whereas the R_Def value specific for the total data flow within the cell is used as a variable which can be dimensioned on the basis of the number of time slots reserved for GPRS transmissions in the cell.

Note that when D is less (larger) than the definition value B_Def, the leak rate R′ is larger (less) than the estimated transmission rate Tr_R. That is, the PCU (like the SGSN) considers that the definition value B_Def is some kind of target value for D, and that thus the actual buffering capacity in the PCU should be larger than B_Def.

It is also to be noted that when the downlink TBF is established, D is rather small (the PCU has at this point only one packet for the GPRS mobile station) and the transmission rate R is zero (i.e. no bytes have been transmitted within this TBF so far). As a result the leak rate value R′ is close to the default value of R_Def.

All parameters relating to each mobile station in the cell are stored in the memory of the PCU for the duration of the TBF.

After determining the new leak rate value R′for a data flow, the PCU transmits a flow control message to the SGSN 403. The message includes identification of the data flow in question, the just determined new leak rate value R′, and the current value of the B_Def parameter. Usually there is no need to change the B_Def value. However, if the selected flow is the total flow within the cell and the number of timeslots within the service area of the GPRS system has been changed, then the B_Def parameter value need to be updated.

The above procedure is repeated at predetermined time intervals (one second, for example) for each of the plurality of downlink data flows.

However, if there is a large number of data flows within the same cell, the consequence is that the flow control algorithm generates a large number of flow control messages, which consume the resources of the network. This problem can be avoided in different ways. Two solutions are described in the following.

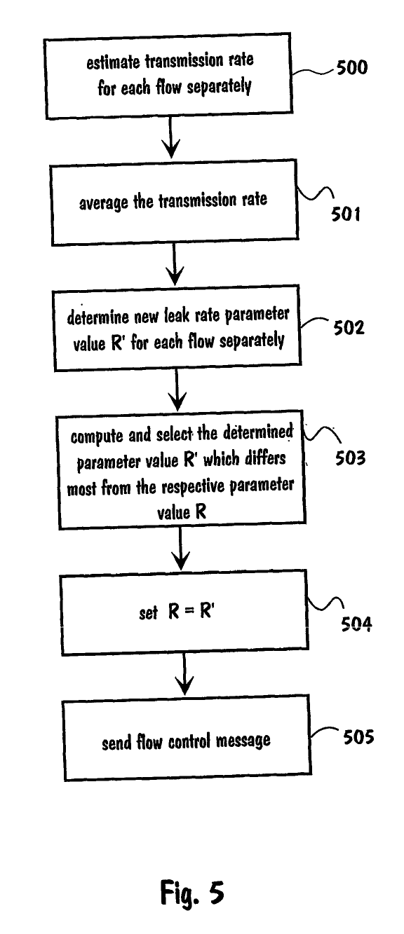

FIG. 5 shows as a flowchart an example of the first solution. Steps 500-502 correspond to steps 400-402 in FIG. 4.

In the first solution the most important function is to identify from a plurality of downlink data flows which particular flow requires flow control the most. Furthermore, it is important to determine what leak rate value is required for the successful transmission of data and that this leak rate value is then sent to the SGSN in a single flow control message specific for the selected flow. For this purpose the PCU first computes and then on the basis of the computation selects from a plurality of the downlink data flows the one whose predetermined leak rate parameter value differs relatively the most from the current leak rate parameter value R used by the SGSN 503. In other words, the PCU computes the relative difference R_Dif for each data flow separately using the following mathematical formula:

R_{—}Dif=|R′−R|/R_{—}Def,

where R′ is the just determined leak rate value and R is the leak rate parameter value currently used by the SGSN.

The largest value for R_Dif determines which of the plurality of the data flows in the cell requires flow control the most, i.e., which of them is to be selected and controlled by a flow control message.

A relative difference is computed because there are different flows in the cell: there is a total data flow through the service area which consists of several sub-flows for particular GPRS mobile stations. The relative difference enables a comparison between the total flow and a sub-flow so that the algorithm is able to decide whether to control single data flow for a GPRS mobile station or the total data flow within the cell.

Note that each time when a downlink TBF is established, the PCU assumes an initial value of R_Def for the SGSN's leak rate parameter because the PCU does not know the current value of R. Later on, when the PCU sends to the SGSN a new leak rate parameter value for a given TBF, the PCU updates the R parameter by setting R=R′ 504.

After determining the new leak rate value R′ for the selected data flow, the PCU transmits just one flow control message to the SGSN 505. The message includes identification of the data flow selected, the just determined new leak rate value R′, and the current value of the B_Def parameter.

The above procedure is repeated at predetermined time intervals (one second, for example) for each cell of the GPRS system.

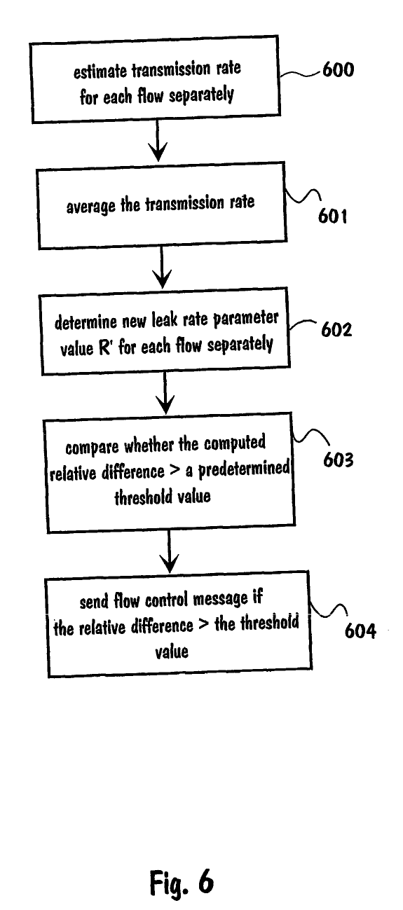

FIG. 6 shows as a flowchart an example of the second solution. Steps 600-603 correspond to steps 500-503 in FIG. 5

The second solution for limiting the number of flow control messages is to determine the relative difference R_Dif for each data flow as above and to then compare each flow separately as to whether the computed R_Dif is larger than a predetermined threshold value 603, 0.1, for example. If the answer is YES, then the PCU sends a flow control message 604 to the SGSN and includes in the message identification of the flow in question, the just determined new leak rate value R′, and the current value of the B_Def parameter.

This procedure is then repeated at predetermined time intervals (one second, for example) for each data flow within the given service area, such as a cell.

Note that this solution may generate several flow control messages within one repetition period if there are several data flows that need controlling. On the other hand, the flow control messages can be omitted completely if there is no data flow requiring control.

Note that the second solution for limiting the number of flow control messages can be used also in conjunction with the first solution so that first the data flow requiring control the most is selected. Then the R_Dif parameter computed for the selected flow is compared with the threshold value as described above.

On the other hand, the PCU may also determine through comparison whether the R′ parameter value to be transmitted to the SGSN is less than a predetermined minimum value R_min. If the answer is YES, the leak rate value R′ is set at R_min. Otherwise, the R′ parameter value is delivered as usual. In this way the following problem can be avoided: if the SGSN is commanded to use a leak rate value of zero, it will delay a data packet an infinite period of time. In practice this means that the SGSN delays the packet until the PCU commands the SGSN to use a non-zero leak rate.

Theoretically, however, it is possible that the PCU's buffer for this particular data flow underflows before the PCU is allowed to transmit a new leak rate value for that data flow. When the PCU's buffer underflows, the TBF is released and the PCU loses its information about the flow and cannot therefore update a feasible parameter value for the leak rate used by the SGSN. This dead-lock situation can be avoided using non-zero leak rate values.

In some cases it may be practical to stop the data flow to the cell completely. This situation can arise if no GPRS timeslots are available in the given cell, for example. In that case the minimum value R_min is set at zero.

The implementation and embodiments of the present invention have been explained above with some examples. However, it is understood that the invention is not restricted to the details of the embodiments above and that numerous changes and modifications can be made by, those skilled in the art without departing from the characteristic features of the invention. Thus, alternative implementations defined by the claims, as well as equivalent implementations, are included in the scope of the invention.

For example, the steps in the algorithm are just examples, and there can be many kinds of different steps The flow control message may also contain other useful information in addition to the information explained in the previous example, such as the predetermined mobile specific parameter values R_Def and B_max_def.

Further, the invention is not technology-bound. Therefore, it can be used with any transmission technology where the flow control is needed. This is most likely to take place with a general packet radio service GPRS system or a edge general packet radio service EGPRS system. However, implementation of the invention can also be carried out in other packet networks.

1. A method of controlling data flow in a packet network comprising
a first network node in which initial flow control parameters are stored and through which data packets are transferred to a second network node,
the second network node, in which data packets are stored in a buffer before being forwarded towards their destinations,
characterized by the steps of:
in the second network node,
monitoring the transmission rate of each of a plurality of data flows, each data flow being formed by the packets destined for a certain destination,
monitoring the degree of filling in buffers associated with each of the data flows,
computing flow control parameter values for each of the data flows based on the transmission rate of the data flow and the degree of filling in the buffer,
sending to the first network node a flow control message which includes an identifier and the flow control parameter values of a data flow, and
in the first network node,
receiving the flow control message and replacing previous flow control parameter values with the new values received,
adjusting the data rate for the data flow based on information in the flow control message, and
transferring data from the first network node to the second network node at the adjusted data rate.

2. A method according to claim 1, wherein the step of computing flow control parameter values is further based on a maximum size of the buffer.

3. A method according to claim 1, wherein the step of computing flow control parameter values is further based on the size of the packets of the data flows.

4. A method according to claim 1, wherein the step of computing flow control parameter values is further based on the time at which a previous data packet was transferred to the second network node.

5. A method according to claim 1, characterized by computing a leak rate parameter value as one of the flow control parameter values, using the steps of:
calculating an average transmission rate;
correcting a default leak rate parameter by a correction factor whose value depends on the degree of filling of the buffer in question; and
adding the corrected default leak rate parameter to the calculated average transmission rate.

6. A method according to claim 2, wherein the correction factor has a negative value when the degree of filling of the buffer in question is larger than a target value thereof, has a positive value when the degree of filling of the buffer in question is less than a target value thereof, and is close to the default leak rate parameter value when no data has been transmitted to the buffer in question.

7. A method according to claim 1, comprising the further step of selecting at least one data flow requiring flow control and wherein the flow control message sent to the first network node includes an identifier and flow control parameter values of each data flow selected.

8. A method according to claim 7, characterized in that the selected data flows are identified by computing, for each data flow, the relative difference between the computed leak rate parameter value and a current leak rate parameter value and selecting the flow whose relative difference value is largest.

9. A method according to claim 7, characterized in that the selected data flows are identified by computing, for each data flow, the relative difference between the computed leak rate parameter value and a current leak rate parameter value and selecting flows whose relative difference value exceeds a predetermined threshold value.

10. A method according to claim 8, characterized by setting a predefined minimum value as the selected leak rate parameter value.

11. A method according to claim 1, characterized in that the steps are repeated at predetermined time intervals.

12. A method according to claim 1, characterized in that flow control can also be performed for one specified user terminal.

13. A method according to claim 1, comprising the further step of comparing the degree of filling of the buffer to a maximum size of the buffer, and, if the degree of filling is not smaller or equal to the maximum size, keeping a data packet in the first network node.

14. A method according to claim 11, comprising the further step of computing a time point when there will be enough space for the said data packet in the second network node.

15. A system for controlling data flow in a packet network comprising
a first network node in which initial flow control parameters are stored and through which data packets are transferred to a second network node,
a second network node, in which data packets are stored in a buffer before being forwarded towards their destinations,
characterized in that the system includes
in the second network node,
first monitoring means for monitoring the transmission rate of the plurality of data flows, each data flow being formed by the packets destined for a certain destination,
second monitoring means for monitoring the degree of filling in buffers associated with each of the data flows,
computing means for computing flow control parameter values for each of the data flows based on the transmission rate of the data flow and the degree of filling in the buffer,
sending means for sending to the first network node a flow control message which includes an identifier and the flow control parameter values of a data flow, and
in the first network node,
receiving means for receiving the flow control message and replacing previous flow control parameter values with the new values received,
adjusting means for adjusting the data rate for the data flow based on information in the flow control message, and
transferring means for transferring data from the first network node to the second network node at the adjusted data rate.
